(19) United States
(12) Patent Application Publication
(10) Pub. No.: US 2003/0031444 A1
(43) Pub. Date: Feb. 13, 2003

(54) Convex polygon-shaped all-glass multi-clad optical fiber and method of fabrication thereof

(76) Inventors: Andre Croteau, Saint-Agapit (CA); Eric Pineau, Boischatel (CA)

Correspondence Address: Wallenstein & Wagner, Ltd., 311 S. Wacker Drive, 53rd Floor, Chicago, IL, 60606-6630, US

(21) Appl. No.: 10/210,627

(22) Filed: Jul. 31, 2002

(30) Foreign Application Priority Data
Aug. 7, 2001 (CA) 2,354,783

(51) Int. Cl. G02B 6/22; G02B 6/16

(52) U.S. Cl. 385/127; 385/123; 65/385

(57) ABSTRACT

An all-glass multi-clad polygon-shaped convex optical fiber comprises a core having a core refractive index, a first glass cladding disposed around the core and having a first cladding refractive index that is lower than the core refractive index of the core, and at least a second glass cladding disposed around the first glass cladding and having a second cladding refractive index that is lower than the first cladding refractive index. The first and second claddings each have a convex polygonal cross-section, e.g. octagonal cross-sections. A method for fabricating such an optical fiber comprises the steps of: (i) mechanically machining an all-glass optical fiber preform having a core and a first cladding into an optical fiber preform having a convex polygonal cross-section; and (ii) fusing at least another glass cladding to the optical fiber preform, thereby resulting in the all-glass multi-clad polygon-shaped convex optical fiber. Step (ii) may comprises collapsing a glass tube onto the optical fiber preform for fusing the at least another glass cladding thereto, or may be achieved is achieved by an outside plasma deposition process. In a further step (iii), an external surface of the all-glass multi-clad polygon-shaped convex optical fiber is mechanically rounding off.

### BACKGROUND OF THE INVENTION

1. Field of the Invention

The present invention generally relates to optical fibers and, more particularly, to multi-clad convex polygonal optical fibers and to methods of manufacturing such optical fibers.

2. Description of the Prior Art

The emergence of optical technologies, such as DWDM (Dense Wavelength Division Multiplexing), wherein multiple data channels have to be amplified simultaneously sharing an available amplifier output power with one another, OISL (Optical Inter Satellite Links), wherein a diffraction-limited beam has to be emitted in free-space and received thousands of kilometers away, and LIDAR (Light Detection and Ranging), wherein the propagation distances prescribe high-power, and the diffraction-limited quality of the optical beam prescribes using single-mode optical fiber amplifiers, has created a demand for an increase of output power of optical fibers, whereby there is an increased interest in optic fiber amplifiers or lasers.

In such amplifiers or lasers, pump radiation is injected in an optical fiber such as to be absorbed by an active material generally being doped in a core section of the optical fiber, to then be converted in a power gain of an output signal. The power output of fiber amplifiers is directly related to the absorbed pump power in the amplifier fiber (rare-earth doped) section, and thus it is related to the amount of pump power that can be coupled into the same fiber.

The amplified signal has to be literally single-mode in order to have stable amplification and diffraction-limited output with high-output power. Thus, the amplification (doped) region must be confined to a single-mode core. For optical amplification to occur, the pump must overlap with the signal in the single-mode doped core. Coupling a pump signal into a single-mode core means using a small area laser diode. In fact, the diode activity area must be smaller than the diameter of the single-mode core to allow efficient coupling. Limiting the pump diode active area limits its output power proportionally which in turn limits the output power of the fiber amplifier or laser.

A known way to get around this limitation is to use a multi-clad doped optical fiber. A multi-clad optical fiber has been known to have at least a cladding layer surrounding a rare-earth doped core. Multi-mode radiation is pumped in the cladding and is eventually absorbed by the core of the fiber. A high-power, broad area (or even diode arrays or matrix) pump diode signal would be coupled to a larger multi-mode region inside which the rare-earth doped single-mode core would be present.

In a multi-clad configuration, the signal is transmitted and amplified through the doped core which has a higher refractive index with respect to those of the cladding layers, which are multi-mode and of lower refractive index, for receiving high-power pump. In essence, radiation will be confined to the highest index region, once it reaches it. For instance, a fiber may have a first cladding section of low refractive index, and a second cladding section of even lower refractive index.

The challenge remains to optimize the efficiency of the amplified fiber. To do so, the overlap of the single-mode core and the multi-mode pump power must be h i g h as possible. This allows to have a lower bleaching power threshold (less pump power wasted) and to be able to use a shorter length of rare-earth doped fiber: lower cost, lower volume, lower background loss, higher nonlinear effect threshold. Also, the rare-earth doped single-mode core must be highly doped and have as large a diameter as possible (R. Paschotla et al., “Ytterbium-Doped Fiber Amplifiers”, IEEE Journal of Quantum Electron, vol. 33, no. 7, pp. 1049-1056, July 1997).

Optical fibers having a circular multi-mode pump waveguide geometry have been provided with their core off-centered, whereby a good overlap is obtained between pump and signal. However, an off-centered core implies not being able to fusion splice these fibers to standard concentric core fibers. In order to ensure an optimal overlap between the multi-mode cladding section receiving the pump and the single-mode signal core while enabling the fusion splicing to standard concentric core fibers, fibers having pump cladding sections of polygonal geometry have been provided, whereby it is ensured that the pump will reach the core section of the fiber. Furthermore, such fibers involve a straightforward fabrication and a robust product, since the geometry thereof is similar to that of standard optical fibers. This is disclosed in U.S. Pat. No. 5,533,163, issued on Jul. 2, 1996 to Muendel, wherein an optical fiber structure having a circular cross-section core, and a polygon-shaped first clad surrounding the core. A second clad surrounds the first clad. The core is rare-earth doped, and has a higher refractive index than the first clad. Similarly, the first clad has a higher refractive index than the second clad. It is noted that the core section and the first clad consist in glass material, whereas the second cladding is made of a polymer.

In the past, there did not exist a fabrication technique allowing to make all-glass convex polygonal-shaped multi-clad fibers, or even all-glass multi-clad fibers of any shape for that matter. The outer cladding was always made of polymers, making the fibers difficult to handle, difficult to fusion splice to standard fibers and with questionable reliability. Aging of the polymer outer-cladding fibers has been demonstrated to be a concern because of the imperfect adhesion of the polymer to glass. High-power damage threshold of the polymer outer-cladding has also been observed to decrease the performance of high-power amplifier and lasers using such a technology. Recently, all-glass solutions have been proposed in order to avoid some, if not all of these problems. For instance, Vienne et al. (Fabrication and Characterization of Yb³⁺:Er³⁺ Phosphocylacate Fiber for Lasers, Journal of Lightwave Technology, vol. 16, no. 11, pp. 1990-2001, November 1998) have proposed to drill a hole within a circular fiber preform and insert the rare-earth doped core rod in order to make an all-glass double-clad fiber.

Another possible all-glass multi-clad configuration has been proposed by Fiber Core Ltd. (Advanced Fiber Optics Products, Fiber Core Ltd. Catalogue, p. 19, 2000) and possibly involves drilling multiple holes into a circular fiber preform in order to obtain a multi-mode pump waveguide geometry having a perimeter defined by multiple circular sections going into one another and thus creating geometrical discontinuities. This last configuration has a centered single-mode core and is quite advantageous over other known fibers. However, it is associated with a very complex fabrication method.

### SUMMARY OF THE INVENTION

It is therefore an aim of the present invention to provide a convex polygon-shaped multi-clad optical fiber having an all glass construction.

It is also an aim of the present invention to provide methods of fabricating optical fibers such as convex polygon-shaped all-glass multi-clad optical fiber.

Therefore, in accordance with the present invention, there is provided an optical fiber comprising a core having a core refractive index, a first glass cladding having a first cladding refractive index that is lower than said core refractive index of said core, said first cladding being disposed around said core, and at least a second glass cladding having a second cladding refractive index that is lower than said first cladding refractive index, said second cladding being disposed around said first glass cladding, said first and second claddings each having a convex polygonal cross-section.

Also in accordance with the present invention, there is provided a method for fabricating an all-glass multi-clad polygon-shaped convex optical fiber, comprising the steps of:

mechanically machining an all-glass optical fiber preform having a core and a first cladding into an optical fiber preform having a convex polygonal cross-section; and

fusing at least another glass cladding to said optical fiber preform, thereby resulting in an all-glass multi-clad polygon-shaped convex optical fiber.

Further in accordance with the present invention, there is provided a method for fabricating an all-glass multi-clad polygon-shaped convex optical fiber comprising the steps of:

mechanically machining an all-glass optical fiber preform having a core and a first cladding into an optical fiber preform having a convex polygonal cross-section; and

fusing at least another cladding to said optical fiber preform;

wherein any one of a glass tube and a glass plasma is used in said step (ii), thereby resulting in an all-glass multi-clad polygon-shaped convex optical fiber.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is a schematic cross-sectional view of a convex polygonal multi-clad optical fiber in accordance with the present invention;

FIG. 2 is a schematic representation of a first method for the manufacture of an optical fiber as in FIG. 1; and

FIGS. 3a and 3b are respectively a schematic side elevational view of a second method for the manufacturing of an optical fiber as in FIG. 1, and an enlarged schematic end view of the optical fiber resulting from the manufacturing method of FIG. 3a.

### DESCRIPTION OF THE PREFERRED EMBODIMENTS

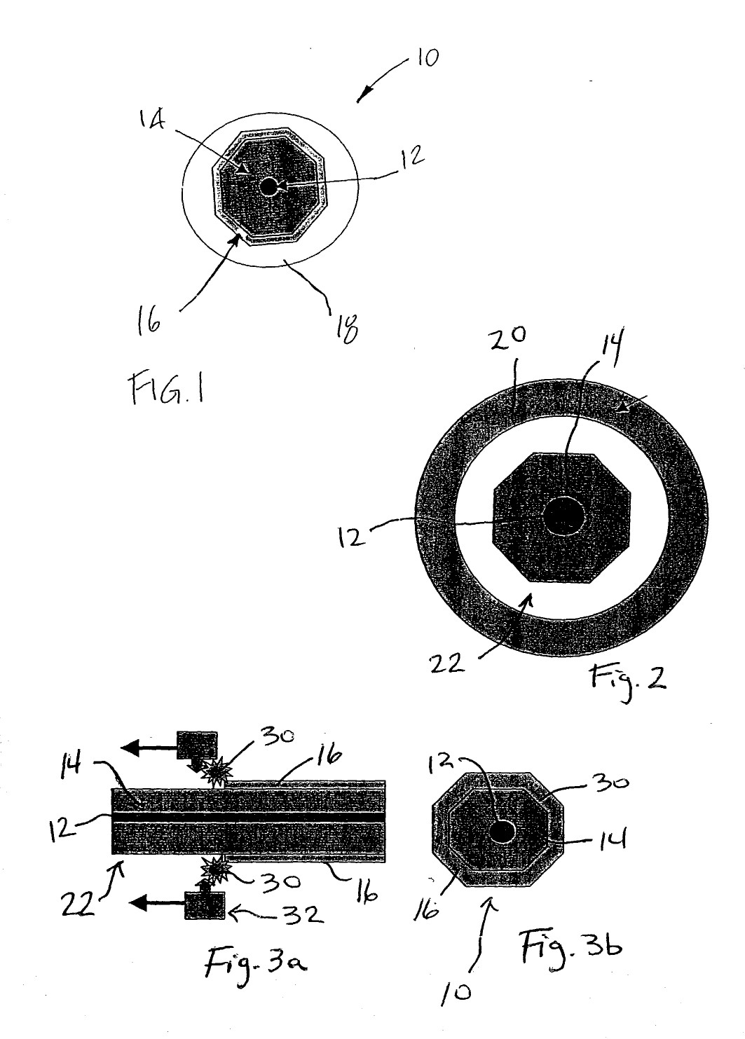

In accordance with the present invention, there is shown in FIG. 1 a convex polygon-shaped all-glass multi-clad optical fiber 10 having an inner cladding 14 between an outer cladding 16 and a core 12. A coating 18 covers the outer cladding 16 of the fiber 10, and may consist of a synthetic material such as acrylate. As known in the art, the core 12 is rare-earth doped, whereby to enable pump radiation absorption therein. The purpose of the inner and outer claddings 14 and 16 is to confine the pump radiation to the inner cladding 14, whereby the radiation intersects the core 12 as it moves along the optical fiber 10. As known in the art, the confinement of the radiation in the core 12 is achieved by using decreasing indexes of refraction from the core 12 to the outer cladding 16.

The inner cladding 14 and the outer cladding 16 are polygonal-shaped in order to ensure the confinement of the radiation in the core 12 over the length of the optic fiber 10. In accordance with the present invention, the core 12, the polygonal-shaped inner cladding 14 and the outer cladding 16 are each made of glass. Although the inner cladding 14 and the outer cladding 16 are shown having an octagonal cross-section, cladding of other convex polygonal cross-sections will efficiently confine the pump to the core 12. The number of claddings can also be made to be more than two. Any of the convex polygon-shaped multi-clad rare-earth doped fibers manufactured according to the present invention, including the core and/or the different claddings, can be made to be polarization-maintaining using any of the known techniques to do so. For instance, elliptical core, elliptical clad, panda or bow-tie configurations and D-shaped sections can be made. These few geometry examples do not limit the scope of the invention which covers any polygon-shaped all-glass multi-clad optical fiber geometry.

Various possible fabrication methods may be used to obtain a convex polygon-shaped all-glass multi-clad optical fiber of the present invention, such as optical fiber 10 of FIG. 1. FIGS. 2, 3a and 3b illustrate two such methods. In these two methods, a fiber preform having a circular geometry has an external surface thereof mechanically machined in order to obtain the required convex polygonal shape which may be, as illustrated, of octagonal shape. The two methods differ in how the glass lower index outer cladding, such as cladding layer 16 of FIG. 1, is fused to the machined fiber preform.

In the first method of FIG. 2, a circular glass tube 20 having a lower refractive index than that of the inner cladding 14 of a machined fiber preform 22 is simply collapsed onto the machined preform 22 by using a proper lathe, thereby forming the outer cladding 16.

In the method illustrated by FIGS. 3a and 3b, a lower index outer cladding glass material 30 is fused to the inner cladding 14 of the machined preform 22 by way of an outside plasma deposition process, generally shown at 32, thereby forming the outer cladding 16. The resulting optical fiber is shown at 10 in FIG. 3b.

In both methods, the edges of the convex polygon will (most probably) be partially rounded off from the outer cladding, while however conserving the general convex polygonal shape.

We claim:

1. An optical fiber comprising a core having a core refractive index, a first glass cladding having a first cladding refractive index that is lower than said core refractive index of said core, said first cladding being disposed around said core, and at least a second glass cladding having a second cladding refractive index that is lower than said first cladding refractive index, said second cladding being disposed around said first glass cladding, said first and second claddings each having a convex polygonal cross-section.

2. The optical fiber according to claim 1, wherein said first and second claddings have octagonal cross-sections.

3. A method for fabricating an all-glass multi-clad polygon-shaped convex optical fiber, comprising the steps of:
(i) mechanically machining an all-glass optical fiber preform having a core and a first cladding into an optical fiber preform having a convex polygonal cross-section; and
(ii) fusing at least another glass cladding to said optical fiber preform, thereby resulting in an all-glass multi-clad polygon-shaped convex optical fiber.

4. The method according to claim 3, wherein said step (ii) comprises collapsing a glass tube onto said optical fiber preform for fusing said at least another glass cladding thereto.

5. The method according to claim 3, wherein said step (ii) is achieved by an outside plasma deposition process.

6. The method according to claim 4, wherein, during the fusion in step (ii), edges defined on an external surface of said tube, which are formed by collapsing said tube on said optical fiber preform, are rounded off.

7. A method for fabricating an all-glass multi-clad polygon-shaped convex optical fiber comprising the steps of:
(i) mechanically machining an all-glass optical fiber preform having a core and a first cladding into an optical fiber preform having a convex polygonal cross-section; and
(ii) fusing at least another cladding to said optical fiber preform;
wherein any one of a glass tube and a glass plasma is used in said step (ii), thereby resulting in an all-glass multi-clad polygon-shaped convex optical fiber.

8. An optical fiber made with the method of claim 3.

9. An optical fiber made with the method of claim 7.
